(19) United States
(12) Patent Application Publication
(10) Pub. No.: US 2020/0389548 A1
(43) Pub. Date: Dec. 10, 2020

(54) FINGER HANDLE FOR A PORTABLE MEDIA PLAYBACK DEVICE

(71) Applicant: Julian Thormaehfen, Adendorf (DE)

(72) Inventor: Julian Thormaehfen, Adendorf (DE)

(21) Appl. No.: 16/737,530

(22) Filed: Jan. 8, 2020

(30) Foreign Application Priority Data
Jan. 8, 2019 (DE) DE201920100057U

(51) Int. Cl. H04M 1/04; F16M 11/04

(52) U.S. Cl. CPC H04M 1/04; F16M 11/046

(57) ABSTRACT

A finger grip (100) for a portable media player with a mounting plate (16) is described, characterized in that a cover plate (17) is provided which is connected to the mounting plate (16) via an elastic connection.

### PRIORITY CLAIM

This application claims priority to German Utility Model No. DE202019100057.0U, filed Jan. 8, 2019 and titled, “Fingergriff für ein portables Medienwiedergabegerat,” the contents of which is incorporated by reference in its entirety.

### BACKGROUND

Portable media playback devices are, for example, modern mobile phones, also called smartphones, portable music and image playback devices, or tablet computers. The portable media playback devices have a housing and a display, which is as large as possible and preferably extends over the entire surface of one side of the portable media playback device. The housing forms the base body and serves to accommodate the electronics and connections, such as power modules, cameras, microphones, speakers, key sensors, etc., and is covered by the display on one side. Portable media playback devices should be configured to be as flat as possible, simultaneously with a display that is as large as possible. This is achieved in that the housing is designed with a cavity that is as flat as possible for the arrangement of the electronics, and the dimensions of the display are such that it maximally covers the opening of the housing. The display can preferably be configured to be touch and/or pressure sensitive, so that the display can be used to play back information as well as to enter commands or data.

When using the portable media playback device, the user holds the portable media playback device in such a way that the entire surface of the display can be viewed, to the extent possible. This is achieved in that the portable media play device is used with the housing in the hand, while the display forms the free surface.

It is further known to place the portable media playback devices in form-fitting shells (cover) or cases in order to protect them from external mechanical influences or to individualize them aesthetically according to the taste of the user.

It is further known to provide portable media playback devices with finger handles, which are attached either directly to the exterior of the portable media playback device or also to the shell or case of the portable media playback device, e.g. by means of an adhesive connection. The finger handle is designed so that the person additionally fixes the portable media playback device by means of engagement of a finger. For this purpose, the finger handle can have a fastening plate for fastening to the portable media playback device and a pivotable ring held on the fastening plate by a pivot bearing, into which the person inserts the finger to fix the portable media playback device. The ring is designed pivotably with respect to the fastening plate by means of a pivot bearing, so that it can be clapped onto the portable media playback device in a flat geometry from an “active position” into a “passive position” when the portable media playback device is not in use, e.g. for placing into a pocket. For the engagement of the finger, the ring is pivoted from the passive position into the active position, in which the person can engage with the ring in a handy and ergonomic fashion. A disadvantage of this finger handle can be seen in that the finger handle with the ring in the passive position forms an uneven surface, because the ring itself and also the pivot bearing for the ring protrude from the surface of the fastening plate.

In light of this, the invention addresses the problem of providing a finger handle for a portable media playback device that should have an improved functionality as well as a geometry that is as flat and even as possible.

To solve this problem, a finger handle is proposed having the features of claim 1. Further preferred further developments can be found in the figures, the corresponding description, and the dependent claims.

### BRIEF DESCRIPTION OF THE DRAWINGS

The features and advantages of the present disclosure will be more fully understood with reference to the following detailed description when taken in conjunction with the accompanying figures, wherein:

FIGS. 1 to 4 show the finger handle according to the invention in the passive and active position in various views.

FIGS. 5 to 9 show the finger handle according to the invention in a sectional view after various assembly steps, in the assembled state, and in an exploded view.

FIGS. 10 to 14 show the finger handle according to the invention in a further developed embodiment in various views.

FIGS. 15 to 17 show a portable media playback device with a finger handle according to the invention in various positions of the finger handle.

### DETAILED DESCRIPTION

According to the basic idea of the invention, it is suggested that a cover plate be provided, which is connected to the fastening plate by means of an elastic connection.

The solution according to the invention is thus based upon the concept of providing, instead of the previously used finger ring, a cover plate that is connected to the fastening plate by means of an elastic connection. Through the elastic connection, it is possible to raise the cover plate out of the passive position adjoining to the fastening plate into an active position, thereby forming a distance to the fastening plate, so that the user can engage the finger into the intermediate space formed between the cover plate and the fastening plate. Several fingers can be inserted, or the elastic section can also be held between two fingers. What is important is that the free space that has been formed has dimensions such that at least one finger can be inserted between the cover plate and the fastening plate, and the portable media playback device can additionally be held by the user by the finger or fingers. The cover plate is embodied in a planar manner and is automatically pulled back into the passive position from the active position by the elastic connection after use and thereby comes into flat contact with the fastening plate. Because, by contrast to the previously used finger ring, the cover plate no longer must be designed specifically for the engagement of a finger and the engagement of the finger is made possible only through lifting of the cover plate, the cover plate can be deliberately designed with a surface that is as even and flat as possible, so that the finger handle in the passive position has a homogeneous, even surface and the insertion or removal of the portable media playback device into or from a pocket such as a jacket pocket or or pants pocket is substantially less impeded.

The elastic connection can preferably be formed by means of an elastomer ring surrounding the fastening plate and the cover plate. In the passive position of the finger handle, the elastomer ring surrounds both parts into a compact finger handle on the portable media playback device and, due to its direction-independent elasticity, allows a lifting and a movement of the cover part in various directions with respect to the fastening plate. The finger handle can thereby be moved into additional positions, e.g. for setting up the portable media playback device on a substrate, which increases the functionality of the finger handle. The elastomer ring further forms a protection for the fastening plate and the cover plate on the radial exterior against external mechanical effects and can also be cost-effectively produced in a complex geometry in a large-scale production process, e.g. in an injection process. The elastomer ring further provides the advantage of a haptically high-quality impression of the finger handle and prevents the scratching of surfaces when the portable media playback device is laid down with the finger handle, e.g. on a transparent plastic table.

It is further suggested that the elastomer ring has a thickness which corresponds at least to the sum of the thicknesses of the fastening plate and the cover plate. Thus, in the passive position, the elastomer ring overlaps both the fastening plate and the cover plate in height. Ideally, the thickness of the elastomer ring corresponds exactly to the sum of the thicknesses of the fastening plate and the cover plate, so that the three parts form a compact block that is as even as possible in the passive position.

According to another preferred further development, it is suggested that the elastomer ring be connected in a first section to the fastening plate, in a second section to the cover plate, and, in at least a third section that is arranged between the first and second sections, is connected to neither the cover plate nor the fastening plate. The third section, in which the elastomer ring is not connected to either of the two parts, allows the mobility of the cover plate with respect to the fastening plate, while the first and second sections serve to connect the elastomer ring to the two parts. The dimensions of the third section can be used to configure the height up to which the cover plate should be liftable with respect to the fastening plate. Moreover, the mobility of the cover plate is also supported naturally by the elasticity of the material of the elastomer ring itself.

It is further suggested that the elastomer ring in the circumferential and/or radial direction has a varying thickness to form a handle recess. Due to the varying thickness, at least one area is deliberately created in which the distance between the elastomer ring and the surface of the portable media playback device is greater than in the remaining area of the whole, so that the user can lift the cover plate by inserting one or more fingers in this section, which is formed as a handle recess, with particular ergonomic convenience.

Here, the handle recess is preferably provided on the second section of the elastomer ring, which is connected to the cover plate, so that the user can lift and/or tilt the cover plate with respect to the fastening plate in a particularly handy fashion.

It is further suggested that the fastening plate and the cover plate have an identical external shape. The cover plate can thereby be placed on the fastening plate such that it increases the height of the fastening plate without the formation of steps or heels on the radial exterior. The cover plate and the fastening plate thus form a compact block, wherein the fastening plate is fully covered without the cover plate protruding over the fastening plate radially outwards.

Preferably, the fastening plate and/or the cover plate can be formed of two parts, a first part and a second part, so that it can be used, for example, to receive additional components such as light sources, sensors, displays, etc.

In particular, the elastomer ring can be defined in this case with a heel between the first part and the second part of the fastening plate and/or the cover plate. The elastomer ring is thus defined with the heel between the first and the second part of the fastening plate and/or the cover plate.

It is further suggested that the cover plate be fixable to the fastening plate by means of a magnetic force. By means of the magnetic force, a connection can be realized that is easy to disengage and restore, without requiring any particular shaping of the fastening plate and/or the cover plate.

Here, a magnet can preferably be provided on the fastening plate and/or the cover plate, which is aligned and arranged such that it defines a target position of the cover plate with respect to the fastening plate by means of its magnetic field. Thus, in the movement out of the active position, the cover plate is additionally aligned from the raised position i.e. into the passive position i.e. into the adjoining arrangement with respect to the fastening plate. In this case, the cover plate can be centered as well as aligned in the rotation angle position with respect to the fastening plate.

The magnet can preferably be fixed between the first part and the second part of the fastening plate and/or the cover plate. As a result, the magnet is covered on both sides and protected against external effects.

It is further suggested that the finger handle have a base plate, which is fixable onto the portable media playback device, and that the finger handle with the fastening plate be fixable to the base plate in a latch connection. The base plate serves to fasten the finger handle to the media playback device and is itself fastened to the exterior of the housing of the portable media playback device, e.g. by means of a double-sided adhesive connection. The base plate then forms the fastening heel for the finger handle on the media playback device in the fastened position. The finger handle is then connected to the base part by means of the fastening handle by means of a manually simple latch connection, which can be realized in particular without the assistance of tools. Here, the latch connection can be, in particular, a non-destructive, disengageable connection, so that the finger handle can be disengaged from the playback device up to the base plate and subsequently fastened again.

For this purpose, the base plate can preferably have a ring-shaped edge or a ring-shaped bulge, which expands radially outwards from the base plate, and the fastening plate can preferably be fixable to the edge or bulge of the base plate by means of the latch connection. The edge or the bulge thereby form a fastening heel on the base plate for the fastening plate and, due to their radially outward expanding shape, enable a “tongue and groove” engagement of the fastening plate with a corresponding shape in order to realize the latch connection. If the edge and/or the bulge are formed in a circular fashion, then they further allow an endless rotating connection of the fastening plate with respect to the base plate around a rotation axis arranged centrally with respect to the circular bulge or the circular edge.

It is further suggested that the latch connection be configured in an elastic manner. As a result, the connection process itself can be simplified, and the local maximum load values of the parts engaging with one another can also be reduced. Here, the elastic latch connection is understood to mean any connection that is realized by an elastic deformation of one or more parts of the connection that engage with one another in order to realize the latch connection. In particular, the elasticity is advantageous for the production of the latch connection in that one or more of the parts of the base plate and/or the fastening plate that engage with one another in order to realize the latch connection can be deformed without being destroyed and can subsequently return to the original form by means of their elasticity.

It is also suggested that a securement component be provided, which secures the latch connection between the fastening plate and the base plate against unintentional disengagement in a secure position. By means of the securement component securing the latch connection in the fastened position, the latch connection can be configured for easy handling with a smaller force threshold to overcome, because the unintended disengagement from the fastened position is additionally prevented by the securement component. The latch connection is practically fixed by the securement component in the fastened position.

It is further suggested that the base plate have a profile surface and the fastening plate have a surface that is configured as an impression of the profile surface of the base plate, whereby the fastening plate lies in a fastened position on the profile surface of the base plate. The base plate and the fastening plate intertwine into a compact form through the profile surface and the adjoining impression surface. Additionally, the fastening plate is secured against lateral movement with respect to the base plate.

It is further suggested that the fastening plate have a formation on its free surface upon which the cover plate can be fastened in a tilted position by way of deformation of the elastomer ring. The cover plate can thereby be tilted with respect to the fastening plate and fixed in the tilted position. In the fixed, tilted position, the cover plate then forms a standing surface, whereby, functioning as a tripod, the media playback device can be set up in a prone position with respect to an even surface area. As a result, the visibility of the display can be improved due to an improved alignment of the media playback device to the user without the user needing to constantly hold the media playback device in the hand.

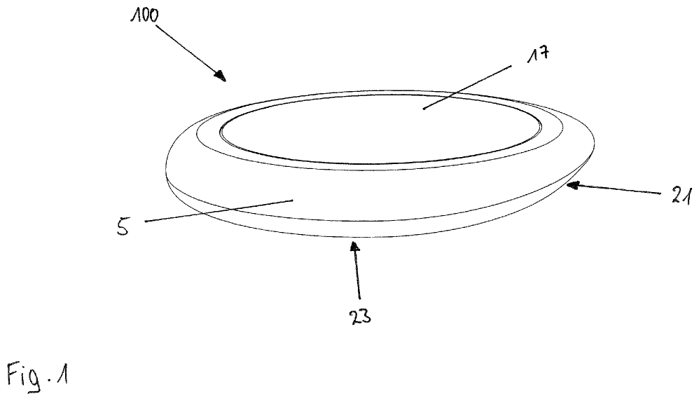

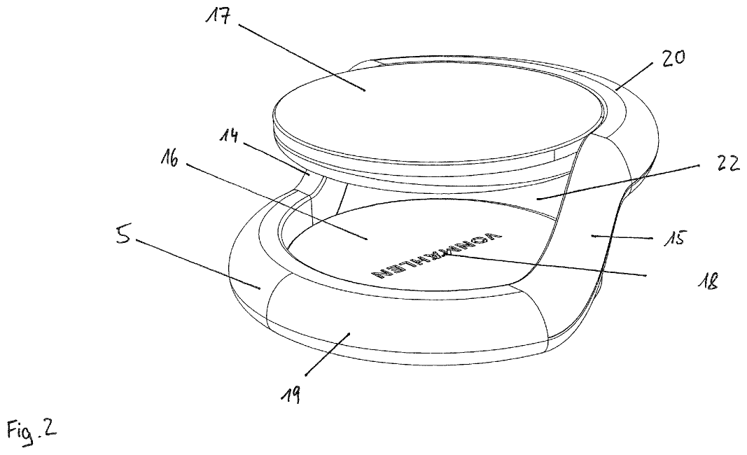

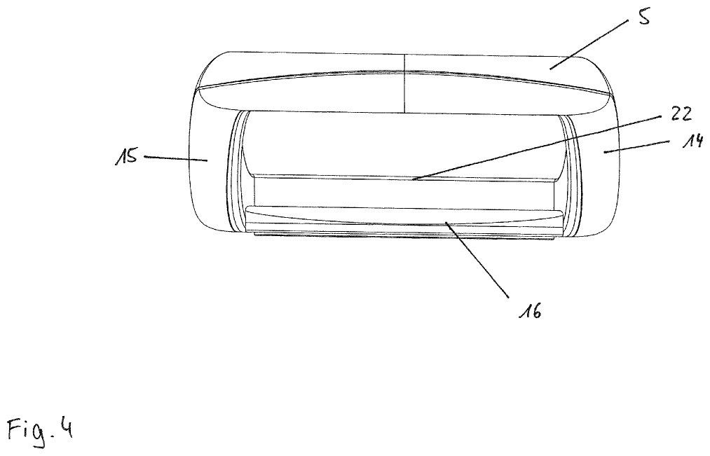

FIG. 1 shows the finger handle 100 according to the invention before it is fastened to the exterior of a housing of a portable media playback device, e.g. by means of an adhesive connection. As can be seen in FIGS. 2 to 4, as its basic construction elements the finger handle 100 comprises a fastening plate 16, a cover plate 17, and an elastomer ring 5 and is attached to the housing of the portable media playback device or a cover of the portable media playback device by means of a bottom 23 of the fastening plate 16. The cover plate 17 is raised in an active position with respect to the fastening plate 16, so that a clearance 22 is formed between the cover plate 17 and the fastening plate 16 for the engagement of one or more fingers of the user.

The elastomer ring 5 is, as described below in further detail, connected to the fastening plate 16 with a first section 19 and to the cover plate 17 a second section 20. Between the first section 19 and the second section 20, the elastomer ring 5 has two third sections 14 and 15, in which the elastomer ring is connected with neither the fastening plate 16 nor the cover plate 17, thereby enabling a movement of the cover plate 17 with respect to the fastening plate 16. The elastomer ring 5 is embodied in a circular fashion and comprises the fastening plate 16 and the cover plate 17 on its radial outer edges. The thickness and height dimensions of the inner radial edge of the elastomer ring 5 are such that the thickness equals the sum of the thicknesses of the fastening plate 16 and the cover plate 17. Thus, the elastomer ring 5 forms a smooth, homogeneous surface in transition to the free surfaces of the cover plate 17 and the fastening plate 16. Further, the elastomer ring 5 is elastic in and of itself, and its dimensions are such that it pulls the cover plate 17 onto the fastening plate 16 in a passive position as the compact form that can be seen in FIG. 1, if there are no effects of exterior forces. In the passive position, the cover plate 17 lies flat on the upper side of the fastening plate 16 and, for its part, forms a homogeneous, even surface of the finger handle 100 due to its even surface. The cover plate 17 and the fastening plate 16 have an identical, circular outer shape, so that, in the passive position, they merge into a cylinder with a total thickness corresponding to the sum of the thicknesses of the cover plate 17 and the fastening plate 16. In addition to the elastic properties of the elastomer ring 5 itself, the mobility of the cover plate 17 with respect to the fastening plate 16 is additionally enabled by the third sections 14 and 15, which are not connected to the fastening plate 16 or the cover plate 17.

The elastomer ring 5 further has a thickness varying in the circumferential direction and in the radial direction, the dimensions of which are such that, in the area of the second section 20 that is connected to the cover plate 17, the thickness decreases radially outwards with formation of an incline, so that a handle recess 21 or a handle heel is formed. The elastomer ring 5 is thus deliberately embodied asymmetrically and, on the first section 19 connected to the fastening plate 16, has a different, in particular thicker and more bulge-like transverse form, while in the area of the second section 20 connected to the cover plate 17, it has an incline on the bottom ascending outwards. Due to the slope, a handle heel or a handle recess 21 is formed, which facilitates the insertion of the finger and also specifies the direction of disengagement of the cover plate 17. The handle recess 21 is deliberately provided on the second section of the elastomer ring 5 connected to the cover plate 17, so that the user can lift the cover plate 17 in a more ergonomically handy fashion by inserting the finger into the handle recess 21 under the edge of the second section 20 of the elastomer ring 5 connected to the cover plate 17 and using these to lift the cover plate 17 into the active position seen in FIGS. 2 to 4.

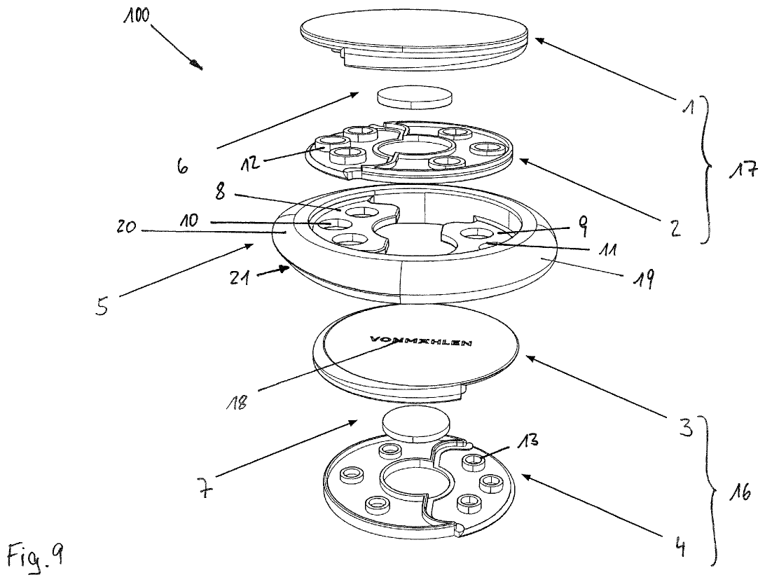

FIG. 9 shows the finger handle 100 with the individual parts in an exploded view. The cover plate 17 and the fastening plate 16 are formed of two parts, a first part 1, 3 and a second part 2, 4, respectively. The first and second parts 1, 2, 3, 4 of the cover plate 17 and the fastening plate 16 are each equipped with a profiling made of various projections 12 and 13, which, among other things, form a central circular receiving area for receiving one magnet 6 and 7 each.

The elastomer ring 5 has two radially inward pointing heels 8 and 9, each having a profiling made of multiple circular recesses 10 and 11. Further, the free upper part of the first part 3 of the fastening plate is equipped with a symbol 18, e.g. in the form of a company logo, which is covered by the arrangement on the fastening plate 16 in the passive position of the cover plate 17 and does not become visible until the active position, i.e. through the lifting of the cover plate 17. The symbol 18 can be used for advertising purposes, for example, and can alternatively or additionally be provided on the free surface of the cover plate 17. However, the arrangement of the symbol 18 on the fastening plate 16 has the advantage of a surprise effect, because the symbol 18 is not visible until lifting of the cover plate 17. This surprise effect leads to an intensification of the memory effect underlying the advertising impact.

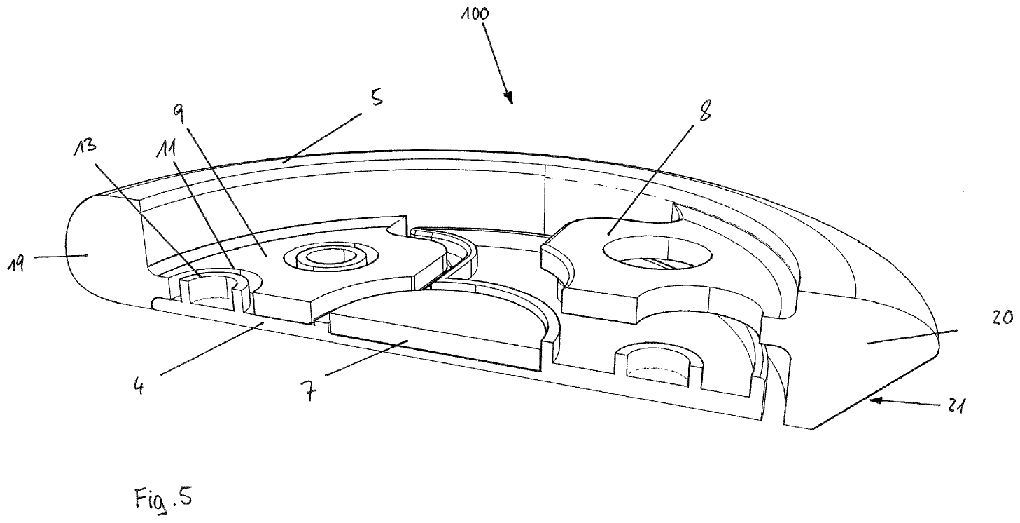

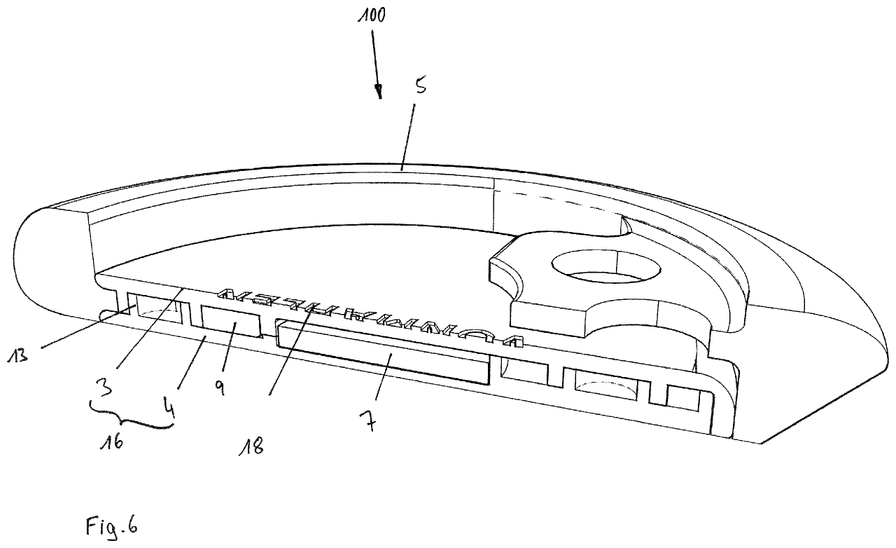

In the following, the construction of the finger ring 100 is further described using various intermediate steps of the assembly shown in FIGS. 5 to 8. For the assembly, the magnet 7 is first inserted into the central receiving area of the second part 4 of the fastening plate 16. Subsequently, the elastomer ring 5 is set up on the second part 4 with its lower heel 9. Here, the elastomer ring 5 is set up such that the second part 4 engages with multiple annular projections 13 into the recesses 11 of the heel 9, so that the elastomer ring 5 is predirected to the second part 4 in a defined target position. The outer dimensions of the annular projections 13 are slightly smaller than the inner diameter of the circular recesses 11, so that a ring gap is provided between the inner wall of the recesses 11 and the outer wall of the engaging projections 13.

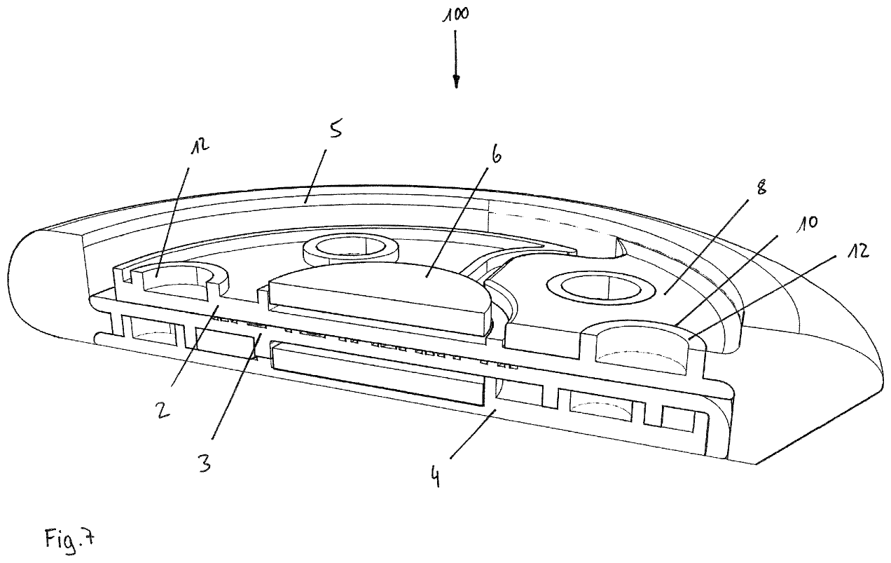

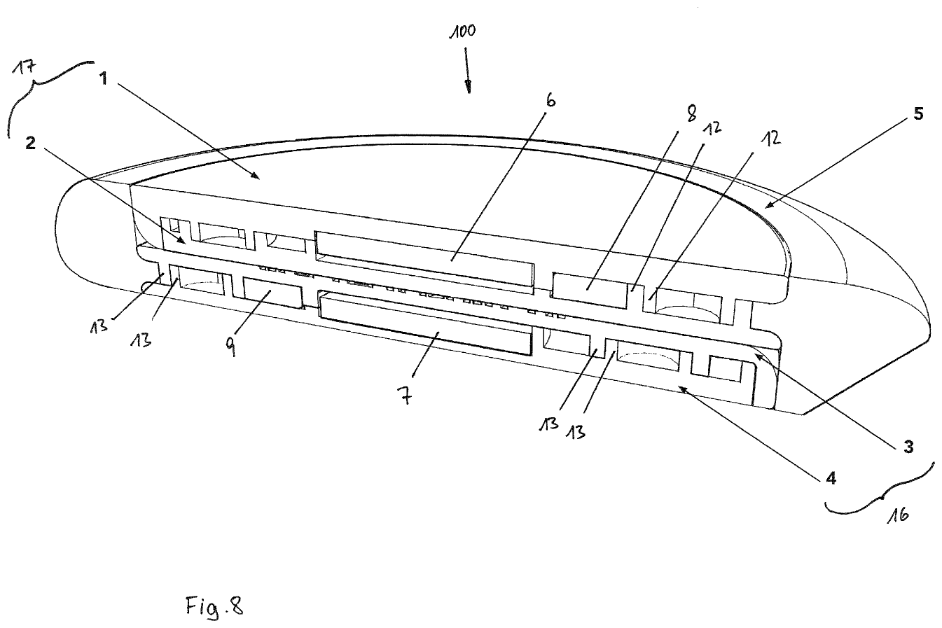

Subsequently, the first part 3 is set up and the fastening plate 16 is completed. Here, the first part 3 similarly has annular projections 13, which engage with the ring gap between the recesses 11 and the projections 13 of the second part 4 during assembly and thereby ultimately fix the heel 9 between the first and second part 3 and 4. Further, the projections 13 engaging with the recesses 11 form a form form-fitting arrangement which secures the heel 9 against removal. In a next step, the second part 2 of the cover plate 17 is inserted under a second upper heel 8 of the elastomer ring 5 by means of a magnet 6 that is already arranged in a central receiving area. The second part 2 of the cover plate 17 similarly has multiple annular projections 12, which engage with one another after insertion into respective circular recesses 10 of the heel 8 of the elastomer ring 5, as shown in FIG. 7. Finally, in a last assembly step, the first part 1 of the cover plate 17 is set up. Here, the first part 1 is set up such that it engages with annular projections 12 into the open spaces of the annular projections 12 of the second part 2, as can be seen in FIG. 8. Thus, the upper heel 8 is laid down between the first and second parts 1 and 2 of the cover plate 17 and secured in a form-fitting manner against removal.

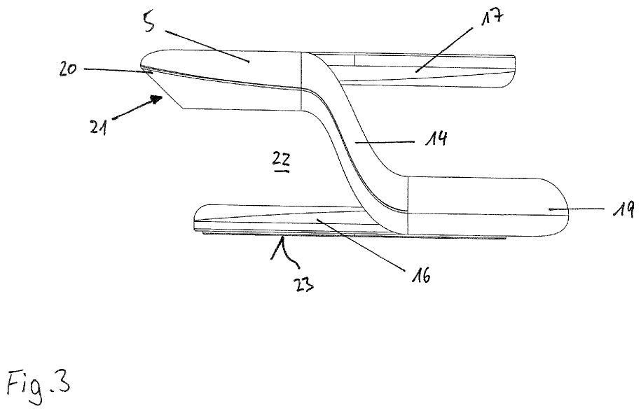

The fastening plate 16 and the cover plate 17 are thus not directly connected to each other. The connection is only formed by the elastomer ring 5 surrounding both parts, which is connected to the fastening plate 16 by a heel 9 and to the cover plate 17 by a heel 8. Because the elastomer ring 5 is elastic in and of itself due to its material composition and is connected to neither of the two parts in the third sections 14 and 15, the cover plate 17 can be lifted out of the passive position and into the active position with respect to the fastening plate 16 in order to form the free space 22, as shown in FIGS. 2 to 3. Here, the elastomer ring 5 can also be stretched in and of itself, so that the inserted finger is practically clamped in the free space 22. The cover plate 17 can additionally be further pivoted with respect to the fastening plate 16 by the third, unconnected sections 14 and 15, in order to form a support surface for the portable media playback device on a substrate such as a table top. Here, it is especially advantageous that the cover plate 17 is connected to the fastening plate 16 by means of an elastomer ring 5, because the elastomer ring 5 additionally forms a slip-resistance support on a smooth surface. Further, by using the elastomer ring 5, the oscillations and collisions that can be transmitted from the substrate to the portable media playback device are dampened and reduced.

Depending on the preferred handling of the portable media playback device, the finger handle 100 can be adhered or otherwise fastened by the person to the free surface of the portable media playback device or to the case in different directions. Thus, the finger ring 100 can be fastened such that the cover plate 17 is lifted by means of a movement of the finger in the longitudinal direction of the portable media playback device underneath the handle recess 21, and the finger is subsequently inserted in the longitudinal direction of the portable media playback device into the thusly formed free space 22. Alternatively, the finger handle 100 can also be mounted such that the handle recess 21 faces one of the longer edges of the portable media playback device. In this case, the user lifts the cover plate 17 by engaging the finger transversely to the longitudinal direction of the portable media playback device underneath the handle recess 21 and lifting the cover plate 17, in order to subsequently engage the finger transversely to the longitudinal direction of the portable media playback device into the thusly formed free space 22. Ultimately, however, the user is free to individually select the orientation of the finger handle 100 on the portable media playback device or the case.

The cover plate 17 is held in the passive position by the magnets 6 and 7 on the fastening plate 16. To disengage the cover plate 17, it is sufficient to overcome the magnetic force and, if applicable, the spring force of the elastomer ring 5, while the fixing of the cover plate 17 in the passive position merely requires contact with the fastening plate 16. In the suggested exemplary embodiment, the magnets 6 and 7 are held centrally on the cover plate 17 and the fastening plate 16 and thereby generate a targeted magnetic field, which, in addition to the spring force of the elastomer ring 5, forces the cover plate 17 into a central position with respect to the fastening plate 16. Further, the magnetic field can additionally be arranged such that the cover plate 17 is additionally forced into a defined rotation angle position with respect to the fastening plate 16.

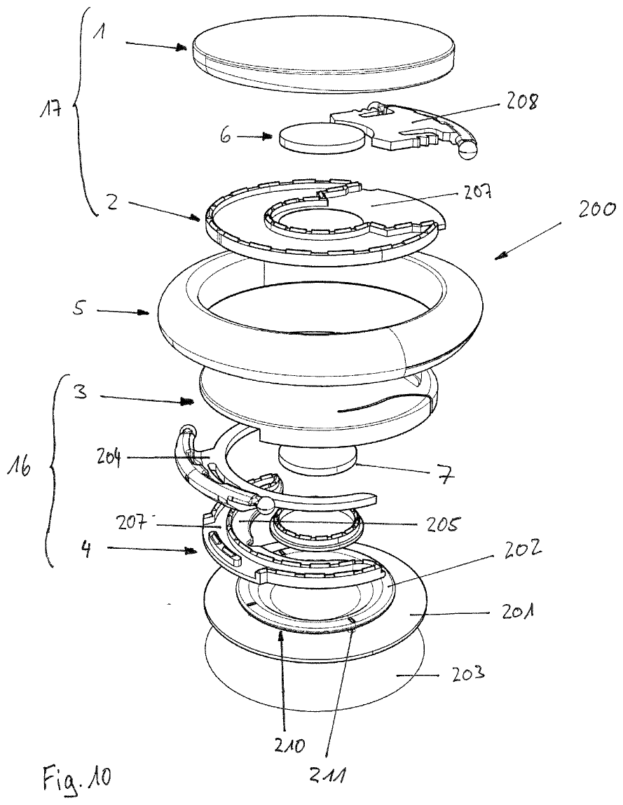

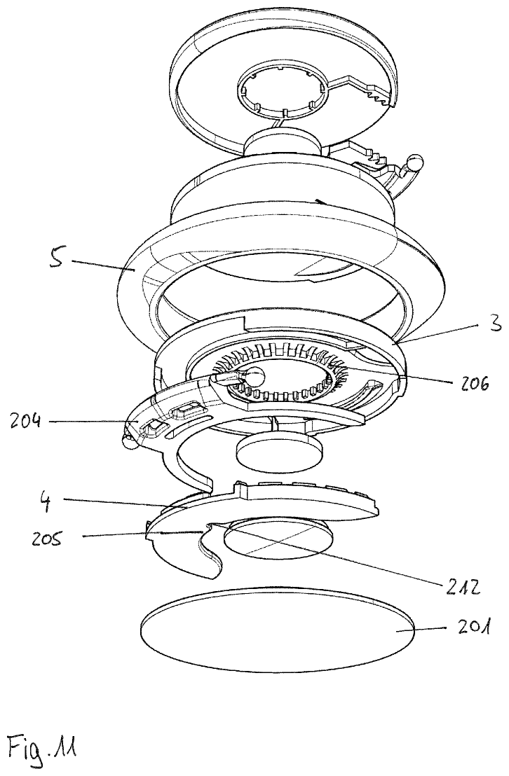

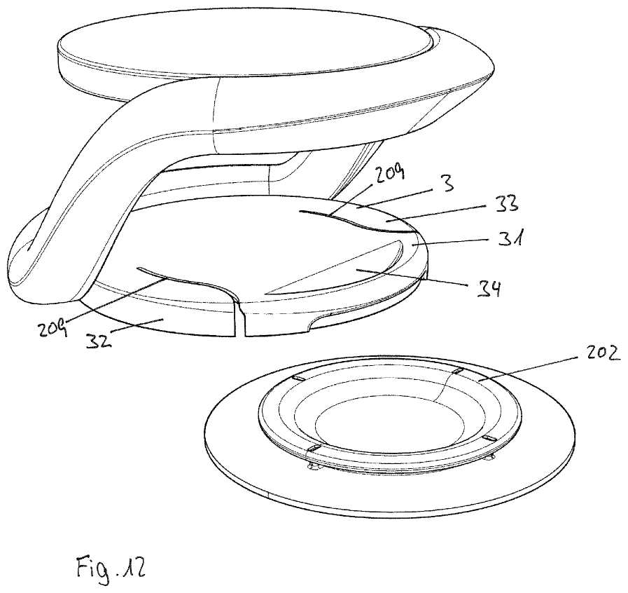

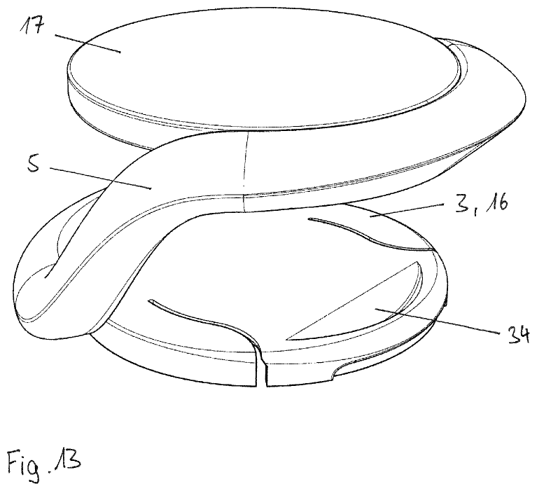

FIGS. 10 to 14 show the finger handle 100 according to a second exemplary embodiment, in which the cover plate 17 and the fastening plate 16 are connected to each other by means of an elastomer ring 5, according to the same principle.

Here, the fastening plate 16 is held to the playback device by means of an additional base plate 201, which itself can be fastened to the exterior of a portable media playback device, for example by means of a double-sided adhesive element 203. The fastening plate 16, as explained in further detail below, is held to the playback device by means of the base plate 201 and itself serves to hold the elastomer ring 5, as already described in the first exemplary embodiment.

The base plate 201 has a ring-shaped bulge 202, which extends from an end face of the base plate 201 and expands radially outward in the shape of a funnel with increasing distance from the base plate 201. As a result, an annular groove 210 is formed on the radial exterior of the annular bulge 202. Instead of the bulge 202, an annular or semi annular edge can also be provided, which extends radially and/or conically outwards. For simplification, the term bulge 202 is used in the following. However, the term bulge 202 is understood to mean any shape that forms a groove with respect to the surface of the base plate 201 due to a radial extension.

Here, the cover plate 17 and the fastening plate 16 are also configured from two parts 1, 3 and 2, 4, wherein a clamping component 208, 204 is held between a first part 1, 3 and a second part 2, 4, respectively, which support themselves on the interior of the elastomer ring 5 by means of the elasticity of the elastomer ring 5 in a clamping manner and thus connect the cover plate 17 and the fastening plate 16 to a section of the elastomer ring 5, respectively, in a clamping manner. Thus, the cover plate 17 and the fastening plate 16 are connected elastically to each other by means of the elastomer ring 5. Here, additional recesses can be provided in the elastomer ring 5, into which the clamping components 204 and 208 engage, whereby the connection can be further reinforced. The clamping parts 204, 208 are inserted into form-fitting recesses 207 of the respective second part 2 and 4 of the cover plate 17 and the fastening plate 16 and are fixed by placing the first part 1, 3 into the recesses 207. The clamping parts 204 and 208 are thus clamped between the first part 1, 3 and the second part 2, 4 of the cover plate 17 and the fastening plate 16, respectively.

The second part 4 of the fastening plate 16 is embodied in a semicircular form and has on its radial interior two radially inward projecting lips 205, which are shaped and arranged in such a way that a semi annular gap is formed between the lips 205 and the first part 3 of the fastening plate 16.

The first part 3 of the fastening plate further has a securement component 31 in the form of an elastic flap that can be lifted from the first part 3 and is arranged between two elastic arms 32, 33 of the first part 3 and is configured to be mobile in by means of two slits 209 in the first part 3 extending into the middle of the first part 3. Further, in the surface of the flap, the first part 3 has a formation 34 in the form of a circular segment-shaped recess with an inclined base area that deepens to the edge of the first part 3.

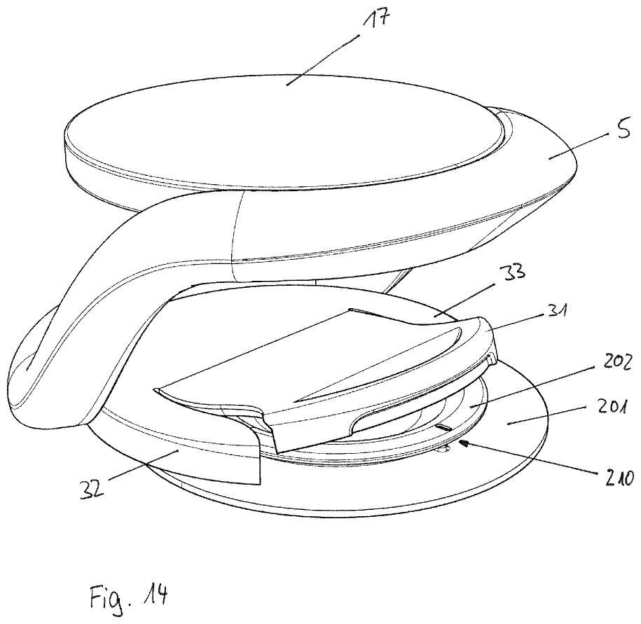

To fasten the finger handle 100, the base plate 201 with the flat end face lying opposite the end face with the bulge 202, is first fastened to the exterior, preferably on the rear side of the portable media playback device, e.g. with the double-sided adhesive element 203. The finger handle 100 is subsequently pushed laterally with the fastening plate 16, as can be seen in FIG. 14. For this purpose, the securement component 31, i.e. the flap, is first lifted by means of its elasticity, so that a free lateral opening is formed on the fastening plate 16. The finger handle 100 is pushed onto the bulge 202 of the base plate 201 with this free lateral opening, so that the annular bulge 202 comes into position between the elastic arms 32 and 33 and deforms the elastic arms 32 and 33 elastically outwards during the further insertion movement. Here, the bulge 202 reaches into the semi annular gap between the lips 205 [and] the first part 3 of the fastening plate 16, in other words, the semi annular lips 205 are inserted into the groove between the bulge 202 and the base plate 201. After the finger handle 100 with the fastening part 16 has been pushed into the final fastened position, the securement component 31 is returned to its securing position, i.e. in this case the flap is pivoted downwards until the lateral opening in the fastening part 16 is closed again, and the finger handle 100 cannot slide laterally from the bulge 202 of the base plate 201.

The groove between the bulge 202 and the base plate 201 is interrupted by four bars 211 arranged at an angle of 90 degrees from each other, which specify predetermined alignments of the finger handle 100 with respect to the base plate 201. Further, the lip 205 is interrupted by a recess 212, which divides the lip 205 into two identical sublips, formed symmetrically to the axis. Further, the lip 205 and the recess 212 are shaped and arranged such that the recess 212 is arranged in the middle of the flap and the lateral opening formed upon lifting of the flap is arranged on the fastening part. The finger handle 100 can only be pushed into the final fastened position once the fastening plate 16 is aligned with the second part 4, so that the lip 205 with the recess 212 is pushed over one of the bars 211. The bars 211 then form an anti-twist protection of the finger handle 100 in the circumferential direction through a form-fitting engagement in the recess 212. To the extent to which it is deliberately intended to provide a rotatabilty of the finger handle 100 with respect to the base plate 201, the bars 211 can also be omitted. In this case, a form-fitting connection of the finger handle 100 to the base plate 201 in the circumferential direction must be avoided in order to realize an endless rotating connection. If only limited rotatability is intended, this can be realized by corresponding stops in the groove or on the base plate 201.

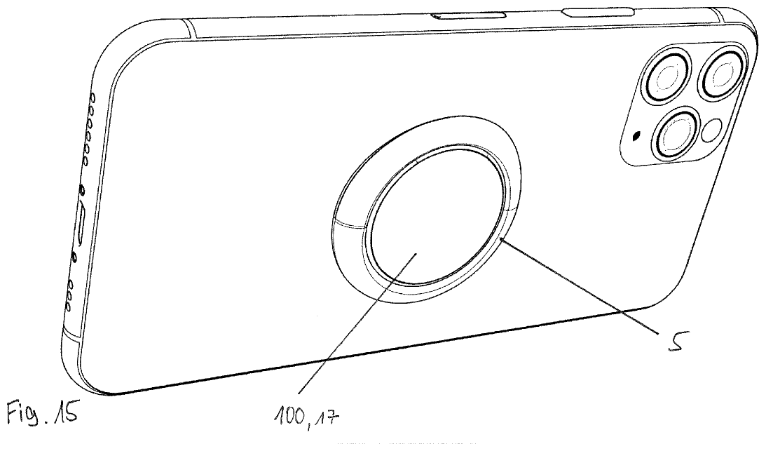

FIGS. 15 to 17 show the various positions of the finger handle 100 on a portable media playback device, such as a smartphone in this case. FIG. 15 shows the finger handle 100 in the non-use position. The cover plate 17 adjoins the fastening plate 16 (not shown), and the elastomer ring 5 is relaxed. The finger handle 100 has a very flat structure. The elastomer ring 5 has a thickness increasing to the middle of the finger handle 100, so that it fills out the corner between the connection of the cover plate 17 and the fastening plate 16 to the surface of the smartphone into a chamfer. Thus, the transition from the finger handle 100 to the housing surface of the smartphone can merge into a chamfer, which facilitates the insertion of the smartphone in pockets and/or prevents the smartphone from hanging on a counter-edge with the body edge of the finger handle 100, which is otherwise present.

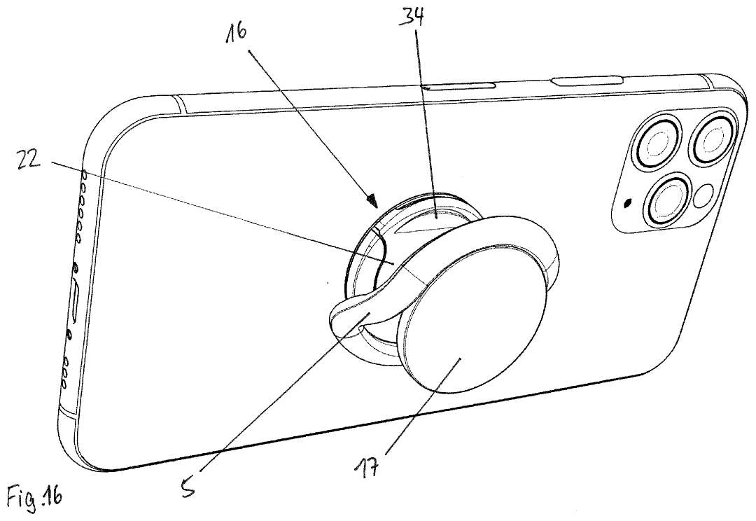

FIG. 16 shows the finger handle 100 with a cover plate 17 lifted from the fastening plate 16, so that a clearance 22 is formed between the cover plate 17 and the fastening plate 16 for the engagement of one or more fingers. For this purpose, the elastomer ring 5 has been tensioned, so that it continues to apply a clamping force to the cover plate 17 in the direction of the fastening plate 16. Thus, the finger can be clamped in the free space 22, and the person handling the device is not required to exert any additional holding force. The smartphone can further be fixed by pushing the free space 22 of the smartphone onto an external object, provided the width of the free space 22 allows pushing onto the external object.

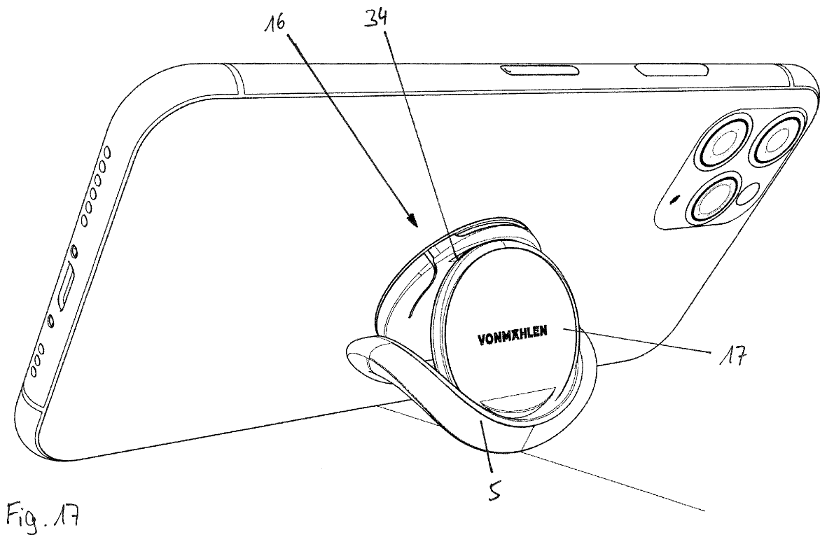

FIG. 17 shows the smartphone with the finger handle 100 used as a tripod. The cover plate 17 is lifted from the fastening plate 16 under tensioning of the elastomer ring 5, and the cover plate 17 has been additionally twisted to the extent that the interior that was previously facing the fastening plate 16 is now facing outwards. For this purpose, the elastomer ring 5 has been twisted to the extent that the section of the elastomer ring 5 that is connected to the cover plate 17 is arranged on the same side as the section of the elastomer ring 5 that is connected to the fastening plate 16. Simultaneously, the free edge of the cover plate 17 is twisted onto the side of the fastening plate 16, on which the formation 34 is arranged in the form of the recess in the surface of the first part 3 of the fastening plate 16. The cover plate 17 is inserted into the recess with its free edge and supports itself on the ground against slipping. The smartphone can thus be set up in an improved visual position, wherein the elastomer ring 5 simultaneously [forms] an elastic standing surface for the smartphone with the section connected to the cover plate 17. As a result, the smartphone itself and also the substrate surface can be protected against mechanical effects. Here, the formation 34 is deliberately configured as a recess with an inclined base area, whose depth increases outwards towards the first part 3 of the fastening plate 16. As a result, the cover plate 17, positioned at an incline to the first part 3, can fit inside the recess with the greatest possible surface area and support itself therein. In practice, due to its shaping, the recess determines the angle position of the cover plate 17 with respect to the first part 3 in the standing position.

The funnel-shaped bulge 202 further forms a profile surface of the base plate 201. On the first part 3, the fastening plate 16 has a form-fitting impression surface in the form of a centrally arranged annular elevation 206 with multiple ribs arranged on the outside. Each rib has a curvature or incline, which merge into a curved or inclined annular lateral surface, whose curvature or incline is an impression of the curvature or incline of the inner edge of the bulge 202. As a result, the first part 3 of the fastening plate 16 achieves the greatest possible surface area contact with the interior of the bulge 202 in the fastened position and is thus simultaneously centered with respect to the base plate 201.

We claim:

1. A finger handle (100) for a portable media playback device comprising:
a fastening plate (16);
a cover plate (17) connected by means of an elastic connection to the fastening plate (16), wherein the elastic connection is formed by an elastomer ring (5) surrounding the fastening plate (16) and the cover plate (17).

2. A finger handle (100) according to claim 1, wherein the elastomer ring (5) has a thickness corresponding at least to the sum of the thicknesses of the fastening plate (16) and the cover plate (17).

3. A finger handle (100) according to any of the claim 1 or 2, wherein the elastomer ring (5) is connected in a first section (19) to the fastening plate (16), in a second section (20) to the cover plate (17), and, in at least a third section (14, 15) that is arranged between the first and second sections (16, 20), connected to neither the cover plate (17) nor the fastening plate (16).

4. A finger handle (100) according to any of the claims 1 to 3, wherein the elastomer ring (5) has a varying thickness for forming a handle recess (21) in the circumferential and/or radial direction.

5. A finger handle according to claims 3 and 4, wherein the handle recess (21) is provided in the second section (20) of the elastomer ring (5).

6. A finger handle (100) according to any of the preceding claims, wherein the fastening plate (16) and the cover plate (17) have an identical external shape.

7. A finger handle (100) according to any of the preceding claims, wherein the fastening plate (16) and/or the cover plate (17) are formed of two parts, a first part (1, 3) and a second part (2, 4), respectively.

8. A finger handle (100) according to claim 7 and according to any of the claims 1 to 6, wherein the elastomer ring (5) is defined with a heel (8, 9) between the first part (1, 3) and the second part (2, 4) of the fastening plate (16) and/or the cover plate (17).

9. A finger handle (100) according to claim 8, wherein the elastomer ring (5) with the heel (8, 9) is secured by means of a form-lock arrangement against a removal from the first and/or second part (1, 2, 3, 4) of the fastening plate (16) and/or the cover plate (17).

10. A finger handle (100) according to any of the preceding claims, wherein the cover plate (17) can be fixed to the fastening plate (16) by means of a magnetic force.

11. A finger handle (100) according to claim 10, wherein a magnet (6, 7) is provided on the fastening plate (16) and/or the cover plate (17), which is arranged in such a way that it defines a target position of the cover plate (17) with respect to the fastening plate (16) by way of its magnetic field.

12. A finger handle (100) according to claim 11 and according to any of the claims 8 to 10, wherein the magnet (6, 7) is fixed between the first part (1, 3) and the second part (2, 4) of the fastening plate (16) and/or the cover plate (17).

13. A finger handle (100) according to any of the preceding claims, wherein the finger handle (100) has a base plate (201) which is fixed to the portable media playback device, and the finger handle (100) can be fastened to the base plate (201) by means of the fastening plate (16) by means of a latch connection.

14. A finger handle (100) according to claim 13, wherein the base plate (201) has a ring-shaped bulge (202) or a ring-shaped edge, which expand radially outwards from the base plate (201), and the fastening plate (16) can be fastened to the bulge (202) or the edge of the base plate (201) by means of the latch connection.

15. A finger handle (100) according to claim 13 or 14, wherein—the latch connection is configured in an elastic manner.

16. A finger handle (100) according to any of the claims 13 to 15, wherein a securement component (34) is provided, which secures the latch connection between the fastening plate (16) and the base plate (201) against unintentional disengagement in a secure position.

17. A finger handle (100) according to any of the claims 13 to 16, wherein the base plate (201) has a profile surface, and the fastening plate (16) has a surface that is configured as an impression of the profile surface of the base plate (201), whereby the fastening plate (16) lies in a fastened position on the profile surface of the base plate (201).

18. A finger handle (100) according to any of the preceding claims, wherein the fastening plate (16) has a formation (34) on its free surface upon which the cover plate (17) can be fastened in a tilted position by way of deformation of the elastomer ring (5).
